(19) United States
(12) Patent Application Publication
(10) Pub. No.: US 2004/0262161 A1
(43) Pub. Date: Dec. 30, 2004

(54) Method for the isolation of salts of organic acids from a fermentation broth and for releasing the organic acid

(76) Inventors: Matthias Rauls, Limburgerhof (DE); Hartwig Vob, Frankenthal (DE); Tillmann Faust, Weisenheim (DE); Thomas Domschke, Speyer (DE); Martin Merger, Frankenthal (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/490,743

(22) PCT Filed: Oct. 9, 2002
(86) PCT No.: PCT/EP02/11306

(30) Foreign Application Priority Data
Oct. 10, 2001 (DE) 101 49 869.1

(51) Int. Cl. G01L 1/20

(52) U.S. Cl. 204/537

(57) ABSTRACT

A process for the isolation of salts of organic acids from an aqeuous solution, in particular from a fermentation discharge, by partial evaporative crystallization and subsequent or simultaneous displacement precipitation of its salts, and for the liberation of the organic acid from the crystals, preferably by means of an electromembrane process, is described.

The present invention relates to a process for the isolation of salts of organic acids from an aqueous solution, in particular from a fermentation discharge, by partial evaporative crystallization and subsequent or simultaneous displacement precipitation of its salt, and for the liberation of the organic acid from the crystals, preferably by means of an electromembrane process.

Organic acids, in particular carboxylic acids, are economically important chemicals which are widely used, inter alia in nutrition, cosmetics or medicine; either as active substances or as intermediates in the preparation of these substances. Thus lactic acid is employed as a preservative in foodstuffs and added to pharmaceutical preparations. Lactic acid monomers form the basis for the preparation of degradable plastics. The polyhydroxyketocarboxylic acid 2-keto-L-gulonic acid (KGA) is a central intermediate in the preparation of vitamin C. The preparation of such organic acids and their secondary products is distinguished by particular demands on purity and yield in all process stages: on the one hand in order to make possible the employment of the final product in the use for human nutrition and on the other hand in order to lower the costs in the preparation if possible.

Organic acids are mainly prepared via conventional chemical synthesis. The “Reichstein process” for the preparation of KGA is a multistage and very laborious process. In recent decades, biotechnological processes have therefore been developed which have less reaction steps and require less protective group chemistry.

In relatively recent processes, KGA is obtained in a single- or multistage fermentative process, for example by the two-stage fermentation of sorbitol via sorbose using microorganisms suitable for this, in some cases specifically modified.

KGA is isolated from the fermentation solutions according to different variants by utilization of conventional fundamental process technology operations such as ion exchange, crystallization, extraction etc. and reacted to give ascorbic acid.

Whereas however, in particular, the fermentative preparation of organic acids, such as, for example, of the carboxylic acids lactic acid, citric acid or gulonic acid, is often very simple, the isolation and purification of the product of the syntheses or of the fermentations is usually difficult and less efficient. In this connection, two factors have a particularly complicating effect.

On the one hand, the product solutions contain impurities in considerable amount, which in some cases are strongly colored. Thus in fermentation solutions, even after only 80% separation of the valuable substance, in general more secondary components are contained in the resulting mother liquors than valuable product. With increasing yield, the coisolation of impurities is therefore more and more probable. On the other hand, under the customary process technology preparation and purification conditions organic acids show a pH- and temperature-dependent tendency to decompose and form troublesome, likewise colored secondary components.

Thus, instead of the direct obtainment of organic acids, such as, for example, KGA, the isolation of salts of these acids, thus, for example, of sodium 2-keto-L-gulonate (Na KGA) is described as advantageous in the literature. The salts have not only a lower sensitivity to thermal stress, but can also be isolated at neutral pHs, at which the tendency to decomposition is lower than in acidic medium. The purified acid can be liberated from the salts in a further process stage, e.g. by ion exchange or electrodialysis.

The specification WO 01/09074 proposes drying the ketogulonate-containing fermentation solution still loaded with cell mass. The dried fermentation broth is then suspended in alcohol and the insoluble constituents of the alcoholic solution are removed. KGA can be liberated using a low-water mineral acid. While KGA dissolves in the alcohol here, the salt of the mineral acid precipitates. No advantages are to be expected with respect to the process technology outlay during the further reaction of the KGA or the work-up of the ascorbic acid to be formed, since no impurities are separated off during the drying. The impurities are dissolved at least partially in the alcoholic solution and have to be separated off again later in a high-loss manner.

EP 0805210 describes the possibilities and limits of isolation of Na KGA from a purified fermentation solution by means of evaporative, cooling or displacement crystallization. In Example 1, it is shown there that in the batchwise procedure at least four crystallization stages with subsequent work-up of the mother liquors and wash water are needed in order to obtain a yield of 95.5%. Further, in Example 2 data regarding continuous evaporative crystallization under laboratory conditions are mentioned, from which only a total yield of 83.6% results. For a large-scale process, this value is inadequately low.

In “Lizi Jiaohuan Yu Xifu” (1998, 14(2), 175-179) Wang describes the purification of mother liquors of a crystallization of Na KGA by treatment with adsorber resins. By partial separation of color-imparting and other troublesome components by adsorption of Na KGA on the resin and washing-out of the impurities, a subsequent crystallization can increase the total yield of a process from 75% of a pure evaporative crystallization up to 94%. This process technology route, however, involves a not inconsiderable outlay for additional process stages, obtainment of large amounts of dilute rinsing solutions and regeneration of the resin.

In JP 52066684, Na KGA is liberated from Ca KGA, concentrated and subsequently precipitated by addition of a solvent, for example of a lower ketone or alcohol. In GB 800 634 a fermentation broth containing 2% of KGA is concentrated down to a quarter and then methyl alcohol added to precipitate 2-KGA. The problems of this procedure consist in the fact that, on the one hand, very large amounts of solvent have to be added in order to obtain high yields. In the case of Na KGA and methanol, for example, an economically inadvantageously high amount of 10 kg of methanol/kg of valuable product has to be employed in order to obtain a yield of 95%, starting from an approximately 18% strength solution which is saturated at room temperature. On the other hand, by addition of the impurity, not only the solubility of the valuable product, but also the solubility of many impurities is reduced very unselectively. On obtaining yields of beyond 90%, the precipitation of the secondary components and thus contamination of the Na KGA is therefore always also brought about.

In the known processes for the the isolation or purification of salts of organic acids, in particular of 2-keto-L-gulonate, the yield is thus restricted by physical properties of the solutions such as, for example, viscosity, color or restricted solubility of the secondary components.

The present invention is thus based on the problem that, in the isolation or purification of organic acids from fermentation broths, in particular of carboxylic acids, such as, for example, ketogulonic acids, lactic acid, citric acid, vanillic acid, idonic acid, gulonic acid, in particular ascorbic acid, 2,4-diketo-D-gulonic acid, 2,5-diketo-D-gulonic acid or 2-keto-L-gulonic acid, either high product impurities thus have to be expected, which then have to be separated off in a high-loss manner in later process stages, or only low yields are obtained with high purities. The processes made available in the prior art are thus very time-consuming on account of the high number of process steps, for example, for the preparation of the fermentation broth or in order to achieve good yields, and moreover ecologically questionable on account of a high consumption of energy and organic, for the most part toxic, solvents.

It is an object of the present invention to make available an advantageous process in order to be able to isolate free organic acids and their salts economically, ecologically and efficiently from fermentation broths.

We have found that this object is achieved by the embodiments characterized in the claims of the present invention.

The present invention relates to a process for the isolation of a salt of an organic acid from a fermentation broth, comprising the steps

a) partial evaporative crystallization; and

b) displacement precipitation of the salt.

The term “organic acid” is understood as meaning a substituted or unsubstituted, branched or unbranched carbon chain of 3 to 20 carbon atoms, preferably of 4 to 10 carbon atoms, more preferably of 5 to 7 carbon atoms, having one or more carboxyl group(s) (—COOH). Preferably, an “organic acid” is thus understood as meaning a carboxylic acid. The carboxylic acid can also carry one or more keto group(s) (—C═O). The organic acid can be prepared, for example, by the fermentative conversion of saccharides, e.g. starch, sucrose or glucose. Examples of organic acids are, for example, ketogulonic acids, lactic acid, citric acid, vanillic acid, idonic acid, gulonic acid, in particular ascorbic acid, 2,4-ketogulonic acid, 2,5-diketo-D-gulonic acid or 2-keto-L-gulonic acid (KGA). The term organic acids likewise includes, for example, acetic acid, maleic acid, malonic acid, salicylic acid, glycolic acid, glutaric acid, benzoic acid, propionic acid, oxalic acid, stearic acid, ascorbic acid, glutamic acid, etc. or mixtures thereof. The organic acid is preferably 2-keto-L-gulonic acid (KGA).

The term “partial evaporative crystallization” is understood according to the invention as meaning that the fermentation broth is partially evaporated so that the salts of the acid to be isolated dissolved therein, in particular of lactic acid, citric acid, ascorbic acid, gulonic acid or 2-keto-L-gulonic acid, partially precipitate, i.e. preferably 10 to 95% of the organic salt remain dissolved in the broth. The evaporative crystallization can be carried out under normal or under reduced pressure.

A part of the evaporative crystallization can be replaced by a “cooling crystallization”. In the process according to the invention, the partial evaporative crystallization can be combined with a “partial cooling crystallization”. The term “partial cooling crystallization” is understood according to the invention as meaning that the fermentation broth, in particular the fermentation solution already depleted in organic salt in the evaporative crystallization, is cooled such that the salts of the acid to be isolated dissolved therein, in particular of lactic acid, citric acid, ascorbic acid, gulonic acid or 2-keto-L-gulonic acid, partially precipitate.

“Partial precipitation” is understood as meaning that after the precipitation of 10 to 95% of the organic salt remain dissolved in the broth.

The term “displacement precipitation” is understood according to the invention as meaning that the salts mentioned, in particular of lactic acid, citric acid, ascorbic acid, gulonic acid or 2-keto-L-gulonic acid, are precipitated from the aqueous fermentation solution by addition of an organic liquid, the organic liquid being miscible with water, the salts mentioned, in particular the salts of lactic acid, citric acid, ascorbic acid, gulonic acid or 2-keto-L-gulonic acid, however, not being soluble or being only poorly soluble. Organic solvents which are miscible with water are polar solvents, e.g. alkyl alcohols such as, for example, methanol, ethanol, n-butanol, isobutanol, 1-propanol, 2-propanol, etc. or alkyl ketones such as, for example, acetone, 2-butanone, propanone, etc.

The term “fermentation broths”, which is used herein synonymously with “fermentation solutions” or “fermentation discharges”, is understood as meaning liquid nutrient media in which organisms, as a rule microorganisms, such as, for example, protists, e.g. fungi, yeasts or bacteria, algae or vegetable or animal cells have been cultured and which consequently can include these organisms. The term includes both media containing biomass and those in which the biomass has been reduced or removed, e.g. by filtration, e.g. by crossflow membrane processes, decantation or centrifugation. Fermentation broths, fermentation solutions or fermentation discharges can contain different amounts of biomass, in particular dissolved substances, such as, for example, proteins, sugars, peptides, or undissolved constituents, such as, for example, microorganisms or cell constituents. One or more substances can be dissolved in the fermentation broth or mixed therewith which preferably improve the extraction, stability or solubility of the constituents, or confer preferred properties, for example pH, conductivity, salt concentration etc., such as, for example, salt or buffer solutions. The fermentation broth can also contain a certain portion of an organic, water-miscible solvent as long as this proportion does not lead to precipitation of the salt mentioned. Substances which bring about disintegration of cells can also be present. The term also comprises fermentation broths which have been prepared as described herein.

As a rule, in the literature firstly the salt of an organic acid is obtained, from which the acid is then liberated and crystallized. This leads, especially in the liberation and crystallization of ketogulonic acid, to a high proportion of by-products, in particular by means of undesired ring closures. The processes described in the prior art, which are based on isolation of the organic acid or its salts from the fermentation broth by evaporative crystallization, describe yields of only 80 to 90%. Higher yields of 95% are only achievable by the combination of a number of crystallization steps (see above, EP 0805210, EP 0359645). By means of a modified displacement crystallization, a yield of pure Na KGA of up to 90% is achieved in JP 52066684 and GB 800634 with unadvantageously high methanol consumption, in the case of Na KGA contamined with impurities, the yield is up to 95%. A combination of evaporative crystallization and displacement precipitation is not described.

By means of the present invention, a process is made available which makes possible economically and ecologically advantageous isolation of salts of organic acids in yields of more than 90%, preferably more than 95%, in one or two stages. Advantageously, 45 the salt of the organic acid is first crystallized and then the acid is liberated only from the redissolved salt. In particular for KGA, this has the advantage that the high proportion of by-products, e.g. by ring closure, is avoided.

Surprisingly it has been found that it is possible to precipitate the greatest part of still dissolved salt of an organic acid from a fermentation broth containing a high proportion of impurities by addition of an organic solvent, in which the organic acid itself does not dissolve, as crystals of high yield and purity without significant coprecipitation of secondary components occuring. This is achieved although the fermentation broth concentrated in volume (mother liquor) assumes an extremely unfavorable ratio of valuable product to secondary components in its composition. Thus it was possible, for example, to obtain KGA in only two steps in yields of 97 to 99% with only slight discoloration and very good purity.

The process according to the invention thus has the advantage compared with the prior art of being able to be carried out not only in only one or two process-economical steps. Advantageously, the process according to the invention, since the displacement precipitation is carried out from a concentrated fermentation solution and thus takes place in a smaller volume than in the prior art, also leads to a significantly smaller consumption of organic solvent. The dilution of the originally highly viscous mother liquor with the organic solvent moreover has the advantage in process terms that the solid-liquid separation is facilitated, which in turn leads to a higher purity and color depletion. Energetically, it is moreover advantageous that a part of the purification process can be carried out under adiabatic conditions, so that there is no necessity for heating or cooling. Finally, the process according to the invention requires only few or no preparatory steps at all for the preparation of the fermentation solution. Finally, it is also advantageous that the process according to the invention makes highly purified substances available even at a very early stage, so that in subsequent stages which are based on the purified substances, yield and purity of the products is improved.

According to the invention, in the process described herein the fermentation solution is evaporated only partially, i.e. to 10 to 95%, preferably to 30 to 90%, more preferably to 50 to 85% or higher depending on the concentration of the starting solution. Preferably more than 75%, more preferably more than 80% and most preferably more than 85% of the water used is evaporated and preferably more than 30% of the acid and especially KGA crystallized. The higher the degree of evaporation, the less displacing agent has to be used.

The maximum evaporation rate or range for the water in the feed depends on the salt concentration in the starting solution. The evaporation range is preferably 95% and more preferably 90% of the water in the feed. In the case of an aqueous 5 to 15% by weight NaKGA solution the maximum evaporation range or degree is preferably 80 to 95% of the water in the solution, preference being given to a maximum evaporation rate of 85 to 90% for the water in the starting solution, for example the fermentation solution.

The suspensions contained preferably have a solids content in the range from 20 to 60% by weight, more preferably in the range from to 50% by weight, for example 40% by weight, and a water content in the range from 30 to 60% and preferably in the range from 40 to 50%, especially for NaKGA, in the suspension. This corresponds to 20-70% by weight of dissolved and solid NaKGA, and preferably 40-60% by weight of dissolved and solid NaKGA are contained.

During the partial evaporation, relatively high yields of very pure salt of an organic acid are obtained. The degree of the evaporation depends on the desired purity of the product and the desired yield. The higher the degree of evaporation is, the higher the yield of desired product and of impurities from the fermentation broth.

Thus, for example, in a fermentation solution freed from cell mass which has been evaporated to 90%, yields in the range of 75% of KGA are achieved. Surprisingly, further valuable product can then be precipitated from the supernatant in higher purity by addition of displacing agent, e.g. methanol. Advantageously, only small amounts of the displacing agent need to be employed in order to precipitate the salt of the organic acid from the supernatant in high purity.

In a preferred embodiment, the evaporative crystallization is carried out at low temperatures and under reduced pressure. Mild reaction conditions avoid the decomposition of the product. Preferably, the temperature in the crystallizer is between 20° C. and 100° C., more preferably between 30° C. and 80° C., most preferably between 40° C. and 70° C.

A pressure of 0.01 bar to 1 bar is preferred, 0.05 bar to 0.5 bar is more preferred, 0.1 bar to 0.3 bar is most preferred.

In a further embodiment, the solids content in the crystallizer is preferably 5 to 60% by weight, more preferably 25 to 50% by weight. “Solids content” in the crystallizer is understood as meaning the proportion by weight of crystallized salt of an organic acid, in particular Na KGA, based on the total amount of suspension.

The evaporative crystallization can be carried out in any desired crystallizer, e.g. in a stirred vessel, forced recirculation, draft tube or fluid bed crystallizer (e.g. Oslo type). Preferably, the crystallizer is also suitable for carrying out the process under lower pressure.

In one embodiment, the process according to the invention also comprises an evaporative crystallization which is combined with a cooling crystallization. In the cooling crystallization, the fermentation broth is cooled after the evaporation with crystallization of the salt of the organic acid. Cooling to 0° C. to 50° C. is preferred, 30° C. to 40° C. is more preferred. The cooling crystallization can be carried out in the same apparatuses as the evaporative crystallization. The cooling can take place by means of vacuum evaporation, direct cooling with a cold-transfer medium or indirectly via heat exchangers. To avoid encrustrations, it is in particular also possible here to use all forms of construction having continuously or recurrently cleaned heat exchanger surfaces, e.g. refrigerated disc crystallizers.

Preferably, between 10 and 95% of the salt of the organic acid is precipitated in the evaporative crystallization or in the evaporative crystallization and the cooling crystallization. Between 30 and 95% is preferred, between 40 and 90% is more 35 preferred. Crystal yields should be above 50-60% if only from the product quality aspect. Particular preference is given to crystal yields of about 60-90% and an evaporation rate in the range from 75 to 95%.

The concentration of the salt of the organic acid in the starting solution is preferably at least 5%, more preferably 7%, even more preferably 10%, even more preferably 12% or more, especially in the case of sodium KGA.

The amount of evaporated solvent and the crystallization fractions achieved depend on the salt concentration in the starting solution. An aqueous 2% sodium KGA solution has to have about 90% of the solvent (water for example) evaporated off to achieve a crystallization, and in the case of an aqueous 15% sodium KGA solution less than 30% to 50% of the solvent is evaporated off.

In a preferred embodiment, the present invention consequently relates to a process where the partial evaporative crystallization is carried out with the following conditions:

i) temperature in the crystallizer between 20° C. and 100° C.;

ii) pressure between 0.01 and 1.0 bar;

iii) solids content in the crystallizer from 5 to 60% by weight; and/or

iv) cooling of the concentrated fermentation broth to 0° C. to 50° C.

Particularly preferably, the process is carried out under the conditions (i) to (iv). Even more preferably, the process is carried out with the following conditions:

i) temperature in the crystallizer between 40° C. and 70° C.;

ii) pressure between 0.1 and 0.3 bar;

iii) solids content in the crystallizer from 25 to 50% by weight; and

iv) cooling of the concentrated fermentation broth to 30° C. to 40° C.

It is most preferable to conduct the crystallization in such a way that the crystallization yields are in the range from 60 to 90% (w/w) and evaporation rates of more than 75% are achieved. It is therefore particularly preferable for the process to be carried out as per (i) to (iv) and for (v) the starting concentration of sodium KGA to be at least 5%.

According to the invention, the displacement precipitation is achieved by the addition of an organic solvent which is miscible with water, but in which the salt to be isolated does not dissolve or only dissolves poorly, to the mother liquor during or after the evaporative crystallization or by addition of the mother liquor to the organic solvent.

By means of the mixing of the aqueous fermentation broth with the organic solvent, a displacement of the salt takes place, which precipitates. The precipitation is preferably achieved by the addition of a water-soluble polar solvent, preferably by addition of a water-soluble alkyl alcohol, e.g. methanol, ethanol, n-butanol, isobutanol, 1-propanol, 2-propanol, hexanols, heptanols, octanols etc. or of a water-soluble alkylketone, e.g. acetone, 2-butanone, pentanone, etc.; methanol or ethanol is preferred. Methanol is most preferred.

The salt is poorly soluble in the solvent used, preferably nearly insoluble. The solubility of the salt is preferably 7%, more preferably 5%, even more preferably below 3%.

Preferably, the precipitation is carried out using 10 to 80%, more preferably using 15 to 70%, even more preferably using 15 to 60%, most preferably using 20 to 40%, of displacing agent with respect to the aqueous solution or the fermentation broth (feed stream) in the reaction vessel, in particular in alkyl alcohols, particularly in ethanol, methanol or propanol. The amount of displacing agent depends on the degree of concentration in step (a).

It is preferable to use methanol precipitant in the range (based on crystal quantity) from 0.2 kg of MetOH/kg of product to 3 kg of MetOH/kg of product, more preferably less than 2 kg/kg and most preferably from 0.5 to 1.0 kg of MetOH/kg of product, especially when the product is NaKGA.

The purity achieved by the process of the invention after steps (a) and (b) is preferably more than 90%, more preferably more than 95% and even more preferably 96%, 97%, 98%, 99% or higher.

The displacement precipitation is carried out in a preferred embodiment at a temperature in the precipitation apparatus of 0 to 100° C., preferably at 10 to 80° C., particularly preferably at 20 to 70° C.

The choice of the reaction temperature and the proportion of displacing agent depends on the solubility of the salt to be precipitated and of the displacing agent in water. By means of the choice of the reaction temperature, the solubility product of the salt in the solution can be influenced, which has an effect on the proportion of displacement agent which is necessary to precipitate the desired salt (and vice versa).

The precipitation can be carried out in a crystallizer or in arrangements specific for the precipitation having devices for mixing in a controlled manner, e.g. having mixing nozzles.

Consequently, the present invention relates to a process in which, according to the invention, the displacement crystallization is carried out with the following parameters:

i) addition of methanol, ethanol, 1-propanol, 2-propanol, acetone, and/or 2-butanone as displacing agent;

ii) precipitation with 10% to 80% of displacing agent with respect to the fermentation broth; and/or

iii) temperature in the precipitation apparatus from 0° C. to 100° C.

Particularly preferably, the process is carried out under the conditions (i) to (iii). Even more preferably, the process is carried out with the following parameters:

i) addition of methanol, ethanol or 2-propanol as displacing agent;

ii) precipitation with 20% to 40% of displacing agent with respect to the fermentation broth; and

iii) temperature in the precipitation apparatus from 20° C. to 60° C.

Evaporative crystallization and precipitation can be carried out in two separate apparatuses or alternatively in a single apparatus, depending on the temperature and pressure ratios and choice of the precipitating agent. Steps (a) and (b) of the process according to the invention can thus be carried out one after the other or simultaneously.

In the case of particularly severely contaminated or discolored mother solutions, in particular fermenter solutions, optionally only one evaporative crystallization may be carried out, since in this stage even under these conditions white crystals are always separated off, only the mother liquor can be supplied with precipitating agent (e.g. methanol) and the prepurified crystals which, however, no longer comply with specification, formed here can be fed back into the evaporative crystallization.

Advantageously, a high yield, advantageously of more than 90%, preferably of more than 95%, particularly preferably of more than 97 or 98%, most preferably 99% or more based on the KGA content of the starting fermentation solution (feed solution) is achieved in only one or, if necessary, in two steps.

According to the invention, the crystals obtained can be washed in order to remove impurities present. Preferably, the crystals are washed with a solvent in which the salt of the organic acid has a low solubility, preferably no solubility at all. Preferably, the solvent of the displacement precipitation is used. The yield of the process according to the invention can be increased by the recycling of wash waters. The yield is dependent, in the case of recycling of wash waters, on the amount of solvent employed and thus, for example, adjustable between 95 to 99%. Thus the amount of solvent employed can be between 0.2 to 1 kg per kg of salt. In a preferred embodiment, the solvent is methanol or ethanol and the salt to be purified is a salt of KGA, preferably Na KGA.

The crystals obtained by the process according to the invention exhibit only slight discoloration. Depending on process implementation and yield achieved, the crystals are slightly yellow to colorless. Preferably, the crystals are colorless.

Advantageously, a product is also obtained from the process according to the invention, in particular salts of lactic acid, of gulonic acid, of KGA or of citric acid which have a very high purity.

The product accordingly has a purity of preferably more than 95%, more preferably more than 97%, even more preferably more than 98%, even more preferably 99% or more.

In a preferred embodiment, the organic acid is a carboxylic acid, polyhydroxycarboxylic acids are particularly preferred and 2-ketopolyhydroxy-C₆-carboxylic acids are more preferred. Organic acids such as ketogulonic acids or lactic acid, citric acid, vanillic acid, idonic acid or gulonic acid are more preferred. In particular, preferred ketogulonic acids are 2,4-diketo-D-gulonic acid, 2,5-diketo-D-gulonic acid, 2-keto-L-gulonic acid and ascorbic acid. 2-Keto-L-gulonic acid is most preferred.

The process according to the invention can be carried out continuously or batchwise.

In one embodiment, the organic acid is present as a sodium, potassium, magnesium, ammonium or calcium salt. If the free acid is initially prepared, e.g. in a fermentation process as a metabolic product, the salt of the acid can usually be prepared by the adjustment of the suitable pH, for example by addition of the bases NH₄OH/NH₃, MgO, Mg(OH)₂, NaOH, NaHCO₃, Na₂CO₃, KOH, KHCO₃, K₂CO₃, CaOH, CaCO₃, Ca(OH)₂, CaO, or salts of weak organic acids, e.g. formic acid, acetic acid, etc. Sodium salts are preferred. Calcium can be precipitated and filtered off as calcium carbonate by addition of sodium carbonate or the introduction of CO₂ and CaCO₃, for example. The isolation of the sodium salt of 2-keto-L-gulonic acid is most preferred.

In a preferred embodiment of the process according to the invention, the biomass and/or the organic and/or inorganic constituents apart from the organic acid of the fermentation broth to be isolated are reduced. The fermentation broth generally consists of insoluble biomass and organic and inorganic impurities, the inorganic impurities essentially consisting of metallic cations. Thus, insoluble constituents, e.g. biomass such as microorganisms or cell constituents, are preferably separated off before the evaporative crystallization. Solid constituents can be removed by means of common solid/liquid separation processes, e.g. by means of filtration, in particular ultrafiltration or microfiltration, or separation, e.g. skimming off, centrifugation or decantation, e.g. in the presence of precipitating agents or filtration additives, e.g. polyacrylamides.

It can likewise be advantageous to separate off certain soluble constituents of the aqueous starting solution before carrying out the process according to the invention. Thus it can be advantageous to separate off certain metals or proteins at least partially, but a complete separation is not always necessary. By means of further purification steps, such as, for example, micro- or ultrafiltration, proteins and other macromolecular substances can be removed.

The fermentation broth can also be demineralized in order to remove undesired inorganic ions. In particular, it is advantageous to separate off divalent ions.

Inorganic cations can be separated off, for example, by acidifying the broth or, for example, with the aid of a chelator or cation exchanger, preferably of a polymeric cation exchanger.

Consequently, the process according to the invention comprises one or more filtration steps, in particular a micro- or ultrafiltration of the fermentation broth, the boundary between a micro- or ultrafiltration being fluid. In general, the transition from micro- to ultrafiltration is seen as being at a pore size of approximately 100 nm.

For the separation of the cells and/or proteins and obtainment of a purified Na ketogulonate solution, the contaminated solution/suspension can be brought into contact with a membrane under pressure, and permeate (filtrate) can be stripped off on the back of the membrane at a lower pressure than on the feed side. A concentrate (retentate) is obtained which contains cells and/or proteins and a purified filtrate (permeate) is obtained which contains Na ketogulonate. Advantageously, by means of recirculation, mechanical movement of the membrane or stirrer units between the membranes, a relative velocity between membrane and feed solution of between 0.1 to 10 m/s is produced. The separation takes place by concentration of the nonpermeable components.

To increase the yield, a diafiltration step can be carried out subsequently to the concentration. In this, by supply of water to the retentate the concentration of the nonpermeable components is kept constant and the valuable product is converted into permeate.

The membrane process can be carried out in a batch procedure by means of repeated passage of the suspension through the membrane modules or continuously by single passage through one or more feed and bleed stages connected in series.

Preferably, the ultra- or microfiltration is a filtration 1 having a pore size of 200 to 20 nm, preferably of 100 to 50 nm, or a filtration 2 or 3 having a pore size of 100 nm to 5 nm, preferably of 50 to 20 nm, or a combination of the ultrafiltration 1, 2 and/or 3. A pore size of 20 nm corresponds approximately to a separation limit of 20 kD, 5 nm correspond approximately to 10 kD, where the separation limit is very dependent on the respective macromolecule and thus a direct assignment of separation limit and pore size cannot be carried out.

Filtration 1 is carried out according to the invention after the fermentation, filtration 2 is carried out according to the invention after the filtration 1 or or after the fermentation, advantageously filtration 2, however, is carried out after the concentration of the filtrate from filtration 1, as described below. After dissolving the crystals, a filtration 3 can also be carried out, as is described further below. The carrying-out of as few filtration steps as possible is preferred. Consequently, a combination of a filtration 1 after the fermentation with a filtration 2 after concentration of the filtrate from filtration 1 is particularly preferred. The carrying out only of the filtration 1 or 2 is more preferred; the carrying out only of the filtration 1 is most preferred.

The separating layers can consist of organic polymers, ceramic, metal or carbon and are stable in the reaction medium and at the process temperature. For mechanical reasons, the separating layers are as a rule attached to a single- or multilayer porous substructure of the same material as or alternatively of a number of different materials from the separating layer. Examples are:

TABLE 1
Separating layers

| Separating layer | Substructure (coarser than separating layer) |
|---|---|
| Metal | Metal |
| Ceramic | Metal, glass, ceramic or carbon |
| Polymer | Polymer, metal, ceramic or ceramic on metal |
| Carbon | Carbon, metal or ceramic |

Ceramic: e.g. α-Al₂O₃, γ-Al₂O₃, ZrO₂, TiO₂, SiC, mixed ceramic materials
Polymer: e.g. PTFE, PVDF, polysulfone, polyethersulfone, polyetheretherketone, polyamide, polypropylene, polyacrylonitrile

The membranes can be employed in flat, tubular, multichannel element, capillary or wound geometry, for which appropriate pressure-tight modules which allow a separation between retentate and the permeate are available.

The optimal transmembrane pressures between retentate and permeate, depending on the diameter of the membrane pores or the separation limits (indicated in molecular weight units) and the mechanical stability of the membrane, depending on the membrane type, are essentially between 1 and 40 bar, in the case of microfiltrations, for example, between 1 and 10 bar and in the case of ultrafiltrations, for example, between 8 and 40 bar. Higher transmembrane pressures as a rule lead to higher permeate flows. At the same time, in the case in which the feed is supplied at a pressure which is too high, the transmembrane pressure can be adjusted by increasing the permeate pressure.

The operating temperature is dependent on the product and the membrane stability. In the case of Na ketogulonate purification, it is between 20 and 90° C., preferably between 40 and 80° C. Higher temperatures lead to higher permeate flows.

The following membranes, for example, are employable:

TABLE 2
Membranes

| | | Separation limit |
|---|---|---|
| | | (kD) pore |
| Manufacturer | Membrane | diameter (nm) |
| Atech Innovations | UF/TiO₂ on α-Al₂O₃/1, 2 | 20 kD |
| GmbH | UF/ZrO₂ on α-Al₂O₃/1, 2 | 50 nm |
| | MF/α-Al₂O₃ on α-Al₂O₃/1, 2 | 100, 200 nm |
| Rhodia/Orelis | UF/ZrO₂ or TiO₂ on ceramic/1, 2 | 15, 50, 150 kD |
| | UF/ZrO₂ on carbon/1 | 15, 50, 150 kD |
| | MF/ZrO₂ or TiO₂ on | 100, 200 nm |
| | ceramic/1, 2 | |
| Graver | UF/TiO₂ on steel/1 | 100 nm |
| Technologies | | |
| Microdyn Modulbau | MF/homogeneous | 200 nm |
| GmbH | PP-membrane/1 | |
| NADIR Filtrations | UF/polyethersulfone/3 | 5-150 kD |
| GmbH | | |
| | UF/cellulose/3 | 5-100 kD |
| | UF/polyacrylonitrile/1 | 20, 40 kD |
| | UF/polyethersulfone/1 | 40, 100 kD |
| Stork Friesland B.V. | MF/PVDF/1 | 100 nm |
| | UF/PVDF/1 | 30 nm |
| Osmonics/Desal | UF/modified polyacrylonitrile/3 | 100 kD |
| | UF/polysulfone/3 | 40 nm |
| Creavis | UF/ZrO₂ on α-Al₂O₃ and | 25, 80 nm |
| | metal/3 | |

1: Tubular membrane;
2: Multichannel element;
3: Flat membrane for wound, bag or stacked plate modules, special modules having stirrer units or movable membranes

A pore diameter of 50 nm is particularly preferred. The separation of proteins and biomass before the crystallization and the liberation of the organic acid by means of electromembrane processes has the advantage that discoloration or protein deposits cannot occur there.

As mentioned above, in addition to the synthetic preparation of organic acids a number of processes have been developed in which organic acids are prepared by means of microorganisms. Thus, for example, D-glucose is converted by fermentation to 5-keto-D-gulonic acid and this is then converted by fermentation or chemically to L-idonic acid and oxidized to 2-keto-L-gulonic acid. D-Sorbitol can be fermented to 2-keto-L-gulonic acid via fermentation to L-sorbose.

The fermentation process can be aerobic or anaerobic. The microorganisms or cells can be separated off before the isolation of the organic acid and optionally fed back to the fermentation process again.

In one embodiment, protists, e.g. yeasts, fungi, algae, or other eucaryotic microorganisms, or bacteria or plant or animal cells are used for the preparation of the fermentation broth. Preferably, microorganisms of the genera Bacillus, Lactobacillus, Pseudogluconobacter, Pseudomonas, Corynebacterium, Proteus, Citrobacter, Enterobacter, Erwinia, Xanthomonas, Flavobacterium, Acetobacter, Gluconobacter, Aspergillus, or Brevibacterium or mixtures thereof are employed. Likewise, homogenates of plant material, animal cells or algae can be used as starting material and are likewise understood under the term “fermentation broth”, if necessary, a specific starting material must be purified or diluted beforehand.

It may be advantageous to sterilize the fermentation broth before the isolation of the organic acid described herein and its liberation.

In the fermentative preparation, in general, between 1 and 30% by weight, as a rule between 7 and 18% by weight, of the organic acids are formed in the fermentation broth at room temperature or approximately 20° C. Correspondingly the salt concentration of the organic acid is between 1 and 30% in the starting solution of the process described herein. The salts of the organic acids can, like, for example, Na KGA, have a lower solubility than the free acids. Thus Na KGA has a solubility of 18% at approximately 20° C., higher temperatures in the fermentation broth lead to higher solubilities of the salts. The solubility of Na KGA is, for example, 24% at 50° C. Preferably, the fermentation broth or the starting solution has a content of Na KGA of between 5% by weight and 15% by weight at 20° C. as described above. However, the concentration of the salt will depend on the nature of the organic acid, the cation and further process conditions, such as, for example, temperature, and is selected such that the fermentation broth does not crystallize out at RT, i.e. 15° C. to 25° C. and normal pressure, i.e. at 980 to 1100 mbar.

The fermentation broth can optionally be concentrated before or after the removal of the biomass and other impurities, for example by evaporation or by osmosis, in particular by reverse osmosis, and thus the concentration of the broth can be adjusted to the crystallization. In this connection, low temperatures, if possible 10° C. to 90° C., are advantageous.

Preferably, the fermentation broth is carried out before the crystallization and after one or more filtration steps. Particularly preferably, the concentration is carried out after filtration 1.

In a further embodiment, the process according to the invention includes one or more further step(s) for the separation and/or preparation of the crystals or of the product.

Solid-liquid separation processes, e.g. filtration, decantation, filtering with suction, skimming, and/or centrifugation, i.e., for example, separation with the aid of suction filters, rotating filters, band filters, shear centrifuges, bowl centrifuges etc. are suitable for the separation, according to the invention. The crystals can be dried and/or ground after the separation and then stored or further processed.

The crystals of the salt of the organic acid obtained contain, depending on the drying process, water of crystallization which can be removed by further drying steps. Thus 2-keto-L-gulonate can be isolated as the monohydrate. The water of crystallization can be removed, for example, by further drying under reduced pressure and, if appropriate, by heating.

The crystals can then be taken up in water or another polar solvent, e.g. branched or linear aliphatic alcohols having 3 to 7 carbon atoms, in particular methanol, ethanol, n-propanol, isopropanol, butanol, hexanol or heptanol.

In order to remove undesired coloring impurities from the crystals, an extraction of the crystals according to the process known to the person skilled in the art can optionally be carried out.

The process according to the invention also includes steps in order to liberate the purified acid from the isolated salts in one or more further process stage(s), which can be achieved, in particular, by protonation of the acid, e.g. by means of an ion-exchange process step or by means of an electromembrane process step, e.g. by means of a membrane electrolysis or an electrodialysis.

In the ion-exchange process steps, the cation of the salt is replaced by a proton situated on the exchange resin and the acid is liberated in this manner.

In electromembrane process steps, the cations of the salts (“counter ions”), e.g. sodium, potassium or calcium ions, and the ions of the acid are cleaved and collected spatially separately by means of ion-selective membranes. Advantageously, the separation is carried out by means of the influence of an electrical field. The acid anions react with protons (H⁺), which are liberated or made available, to give the free acid, e.g. KGA or ascorbic acid, while the counterion reacts with hydroxide ions (OH—) which are released in parallel or made available, to give the corresponding base, e.g. NaOH.

Depending on the ion-selective membrane employed and electrodes employed, various embodiments of the electromembrane process are distinguished. In the membrane electrolysis, charged particles are separated off by means of an ion-exchange membrane in an electrical field and protons and hydroxide ions are generated by electrolysis of water on electrodes. An arrangement of electrodes, in addition to the simplest circuit with only terminal electrodes, is also possible with bipolar membranes, as in the electrodialysis, and the (then bipolar) electrodes then replace the bipolar membrane. In the electrodialysis, the protons and the hydroxide ions are generated by means of an electrically forced dissociation of water on a bipolar membrane. A low energy requirement and avoidance of the oxidation or reduction of other constituents of the solution is advantageous if the electrodes are separated from the acid, base or middle chamber by a dedicated circulation.

Thus, an organic acid isolated according to the invention, which is taken up in water or an aqueous solution, can preferably be dissociated and spatially separated under the influence of an electrical field into anion and metallic counter cation by means of one or more ion-selective membrane(s) and the liberated acid and the corresponding hydroxide can then be prepared by simultaneous production or provision of protons and hydroxide ions. Electromembrane process steps are described, inter alia, in EP-A-0230 021, WO96/41021, U.S. Pat. No. 50747,306, U.S. Pat. No. 4,990,441, and in European Membrane Guide, publisher Mulder, Netherlands, 1997, pages 35 to 38. Such electrodialyses for the liberation of organic acids from their salts are described in general form, for example, in Mani, Desalination 68 (1988) 149-166 and Nagasubramanian, J. Membrane Sci. 2 (1977) 109-124. WO 96/41021 claims a process for the liberation of organic acids from fermentation solutions which have been freed of impurities by filtration steps. U.S. Pat. No. 6,004,445 and EP 779286 claim the liberation of ascorbic acid from its alkali metal salt by electrodialysis using bipolar membranes. WO 99/61647 describes a process for the separation of ketogulonate (KGat) from a fermentation solution with simultaneous liberation of the free KGA by bipolar electrodialysis. In Yu, Chemical Engineering Journal, 78 (2000) 153-157, the liberation of ascorbic acid or KGA by electrodialysis from fermentation solutions is described. The contents of these documents and the references cited therein are regarded as also included.

In a further, preferred embodiment according to the invention, the multivalent cations are removed from the solution to a content of down to 15 ppm, preferably down to 5 ppm, more preferably down to 3 ppm, most preferably down to 1 ppm. Advantageously, the multivalent ions can be removed by treatment of the solution with a chelate-forming ion-exchange resin. Multivalent ions are understood as meaning divalent or higher-valent, e.g. tri- or tetravalent ions, i.e. cations or anions, e.g. Ca²⁺, Mg²⁺, CO₃²⁻ etc. Possible chelate-forming ion-exchange resins are, for example, those which carry iminodiacetic acid groups or aminophosphonic acid groups. These are, for example, Amberlite 718 or 748 from Rohm and Haas. If a calcium salt crystallizes, in the following membrane electrolysis the base cycle will be rendered at least neutral in order to prevent precipitation of hydroxides. This is in principle also possible for monovalent ions if a precipitation of the hydroxides of the counterion is a problem.

Consequently, the present invention relates in one embodiment to a process for the preparation of a free organic acid from its salt and of a corresponding hydroxide of the salt, comprising the isolation according to the invention of the organic acid and furthermore the following steps:

c) dissolution of the crystals of a salt of an organic acid in water or an aqueous solution, so that a crystal solution results;

d) removal of the multivalent cations from the crystal solution; and

e) liberation of the organic acid from the crystal solution, in particular by an ion-exchange or electromembrane process.

In one embodiment of the process according to the invention, the crystal solution according to step (c) has a concentration of the salt of the organic acid of 10 to 50% by weight, preferably a concentration of 15 to 25% by weight.

The process according to the invention can furthermore include the following further step

c) filtration of the crystal solution.

Preferably, the filtration is a filtration 3, which is carried out after dissolving the crystals according to step (c) and/or before the acid liberation according to step (e).

By means of filtration of the crystal solution, coprecipitated impurities, in particular, for example, proteins which would be harmful in the liberation of the acid, can be removed. The advantage of a filtration 3 is that a lower feed stream volume in comparison to the filtrations 2 described above has to be purified, since the crystal solution as a rule has a higher concentration of the salt of the organic acid. It is moreover advantageous that a portion of the impurities is not coprecipitated, so that the feed stream is already prepurified. It is furthermore advantageous that some of the proteins denature and coagulate during the crystallization and precipitation in water using alcohol, in particular ethanol or methanol, and thus the membrane can be better utilized.

For a protein separation, it is possible to use, for example, the membranes described above, for example having a pore size from 100 to 5 nm, preferably from 50 to 20 nm. The filtration can be employed, for example, instead of the filtration 2.

Preferably, the liberation of the acid mentioned is carried out by means of an electromembrane process, particularly preferably by means of a membrane electrolysis or an electrodialysis. As described above, the protons or hydroxide ions can be generated by electrodialysis or on bipolar membranes. It is moreover advantageous that no additional chemicals have to be used in such a process step. Moreover, depending on the embodiment, in addition to the free acid also the alkalis can be obtained as valuable substance. In an electromembrane process, the cation of the dissolved salt (counterion) and/or the anion of the dissolved salt of an organic acid is separated from the crystal solution (feed stream for the electromembrane process) in an electric field by means of one or more ion-selective ion-exchange membrane(s). The salt can be dissolved, for example, in water or in an aqueous solution. The separation of the anion from other impurities of the feed stream is particularly advantageous. Both ions of the feed stream, for example of the crystal solution, can also be separated. The cations and anions of the salt mentioned react with simultaneously generated or provided protons and hydroxide ions such that the free organic acid and the corresponding hydroxide of the counter cation is prepared. Protons can be provided, for example, by addition of acid, hydroxide ions, for example, by addition of bases.

In one embodiment of the process according to the invention, an anion- or cation-exchange membrane is consequently placed between a terminal anode and a terminal cathode, such that an anode and a cathode chamber are formed, the free organic acid being produced in the anode chamber (acid cycle) and the corresponding hydroxide of the counter cation being prepared in the cathode chamber (base cycle).

If a cation exchanger membrane is used, the cations, e.g. the sodium ions, are removed under the influence of the electric field from a chamber through which the crystal solution flows. Electrical neutrality is maintained by means of the fact that each sodium ion is replaced by a proton produced on the anode of the monopolar electrode (acid cycle). The cations migrate through the cation exchange membrane in the cathode direction into the cathode or base chamber, which is flushed, for example, by the base to be produced in order to produce the conductivity, where they react with the hydroxide ions produced on the cathode of the monopolar electrode to give the corresponding alkali, e.g. NaOH (base circulation). If the cation-exchange membrane is replaced by an anion-exchange membrane, the anions of the acid, e.g. the ketogulonate or ascorbate, migrate through the membrane into the anode chamber (acid chamber), which is preferably flushed by a dilute acid, e.g. the acid to be purified, in order to produce the conductivity and reacts there with the protons produced on the monopolar electrodes. The cations remain in the feed solution and react with the hydroxide ions produced on the cathode to give the alkali.

A disadvantage of the two-chamber system with monopolar electrodes is that only either the solution of the base chamber (in the case of a cation-exchange membrane) or the solution of the acid chamber (in the case of an anion-exchange membrane) is separated from the feed stream and thus purified.

In a 3-chamber system with monopolar electrodes, both the acids to be purified and the bases can be separated from the feed stream.

In this case, two selective ion-exchange membranes are placed between a terminal anode and a terminal cathode so that an anode chamber, a middle chamber and a cathode chamber are formed, the middle chamber being separated from the cathode chamber by an ion-exchange membrane and from the anode chamber by an ion-exchange membrane. The ion-exchange membranes can be identical or different, i.e., for example, two anion-exchange membranes, two cation-exchange membranes or one anion-exchange membrane and one cation-exchange membrane can be used.

If, advantageously, one cation-exchange membrane and one anion-exchange membrane are used, the middle chamber forms the entry chamber and will advantageously be separated from the cathode chamber by a cation-exchange membrane and from the anode chamber by an anion-exchange membrane. The crystal solution, for example, from step (c) or (d) is introduced (feed stream) into the middle chamber (or diluate chamber). The ions migrate according to the principle described above. The free acid is then formed in the anode chamber; the corresponding base of the counterion in the cathode chamber.

In a further embodiment, a terminal electrode can be replaced by a bipolar electrode, which is then followed by the same arrangement of the chambers as described above and a terminal electrode. The electrolysis in this package thus takes place on the bipolar electrode.

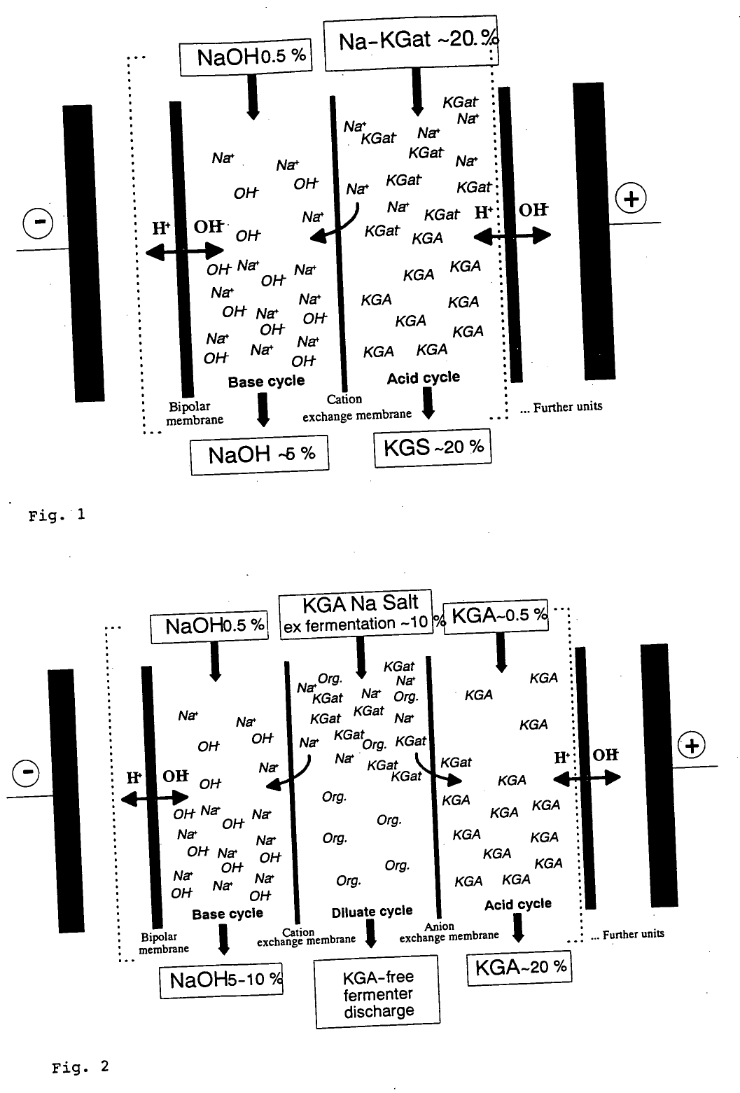

The liberation of the acid mentioned by means of a bipolar membrane electrodialysis with 2 or 3 circulations as shown in FIG. 1 and FIG. 2 is also advantageous.

In a further embodiment, the electrolysis on the terminal electrodes can thus be supplemented by an electrodialysis on a bipolar membrane, which is then followed by the same arrangement of the chambers as in one of the process steps described above and a terminal electrode.

By means of these arrangements, a number of chamber packages can be utilized in parallel for the production of free acid and corresponding base in an electrical field generated by the electrodes. An arrangement of an arbitrary number of 2-chamber or 3-chamber packages, such as have been described above, can thus take place in series, in each case separated by a bipolar electrode.

Preferably, the electrodes are rinsed by individual circulations. This can take place, for example, by the electrodes being surrounded by monopolar membranes which separate the acid and base cycles of the electrodes, such as is shown, for example, in 10 FIGS. 1 and 2. Suitable electrode solutions are acids or bases such as, for example, H₂SO₄, HNO₃, NaOH, KOH etc. or solutions of alkali metal salts such as, for example, Na₂SO₄, K₂SO₄, NaNO₃, KNO₃ etc.

Likewise, the liberation of the acid can be carried out by means of a two-chamber gas diffusion anode cell, such as is described, for example, in U.S. Pat. No. 6,004,445.

In the process according to the invention, anion-exchange membranes can be used which are strongly, mildly or weakly basic, selective and permeable to monovalent anions, but not to cations, the cation-exchange membranes can be mildly or strongly acidic membranes which, for example, contain phosphoric acid or sulfonic acid groups, and allow through monovalent cations, but not monovalent anions. The bipolar membranes have a cation-exchange layer and an anion-exchange layer, the first being permeable to cations and the latter to anions. The cation layer allows no anions through and the anion layer no cations. Examples of such membranes are mentioned, for example, in EP-A-779 286, p8, lines 8 to 24.

In a preferred embodiment, the membrane electrolysis is carried out according to the principle of the electrodialyses shown in FIG. 1 or 2; a 2-chamber system according to the principle of the electrodialysis shown in FIG. 1 is particularly preferred.

In a further embodiment according to the invention, the anion, e.g. Na KGA, is transferred by applying an electrical field to a diluate chamber or middle chamber through an anion-exchange membrane into the acid cycle chamber from a solution which contains the salt of an organic acid e.g. Na KGA. The transferred anion, e.g. Na KGA, is reacted by means of the protons formed on the bipolar membrane to give the free acid, e.g. KGA. The counterions of the anion, e.g. in the case of Na KGA sodium ions, are transferred into the base cycle chamber by means of a cation-exchange membrane and form the corresponding base with the hydroxide ions liberated there on the bipolar membrane. Uncharged particles remain in the diluate chamber, such that a purification of KGA simulatenously occurs. For acid cycle employment, a dilute solution of the free acid, e.g. KGA, is suitable which can originate, for example, from the preceding batch. FIG. 2 illustrates the process principle.

In a preferred embodiment, an electrodialysis step is employed which comprises transferring from the feed solution, which contains the salt of the organic acid, e.g. Na ketogulonate (Na KGA) or another ketocarboxylic acid in an anionic form, and cations, e.g. Na ions, from the acid cycle chamber through the cation-exchange membrane into a base cycle chamber by applying an electric field. The corresponding base, e.g. sodium hydroxide solution, is formed from the transferred counterions, e.g. Na ions, by the hydroxide ions formed on the bipolar membrane and separated off or fed back again in dilute solution. The anion remains in the “acid cycle chamber” and forms the free acid, in particular KGA, with the protons liberated there on the bipolar membrane. FIG. 1 illustrates the process principle and is particularly advantageous in combination with the preceding crystallization steps according to the invention.

In general, the base cycle charge used is the base corresponding to the counterion (in the case of Na salts, for example, sodium hydroxide solution) in higher dilution; only an adequate ionic conductivity of the solution has to be ensured at the start of the electrodialysis. The base formed can, if appropriate after concentration, be employed again in the fermentation. The electrodes are rinsed with an electrolyte solution in a separate circulation in order to avoid undesired reactions of the solution components.

In a further, preferred embodiment, packages such as have been described above e.g. having monopolar electrodes, or having bipolar electrodes or bipolar membranes and the described arrangements of the chambers, are arranged a number of times in series. The 2-chamber packages of acid chamber and base chamber or the 3-chamber packages of acid chamber, base chamber and middle chamber or feed chamber can be lined up a number of times in series. Thus acid anions and counterions can be separated from one another in a number of parallel circulations under only one electrical field.

For example, such an arrangement of terminal anode/anode chamber/1st membrane/cathode chamber/1st cathode/cathode chamber/2nd membrane/anode chamber/2nd anode/anode chamber/ . . . etc . . . last membrane/last cathode chamber/terminal cathode can exist. Further examples of multiple chambers are described in detail in the literature on electrolysis and electrodialysis cited above, known to the person skilled in the art and expressly also included herein.

The feed solution can contain organic or inorganic salts in order to improve the conductivity of the solution if appropriate; for example, alkali metal sulfates, bisulfates, chlorides or phosphates, organic acids, e.g. ammoniumtetrabutyl, ammonium salts, e.g. ammonium chloride etc. can be present. It is preferred that the proportion of other salts is low, most preferred that no other salts are added to the feed solution.

As bipolar membranes, homogeneous or heterogeneous, crosslinked or noncrosslinked polymers can be used which are populated with suitable functional groups, such as, for example, —SO₃⁻, —CO₂⁻, —NR₄⁺ etc., e.g. Neosepta BP-1 from Tokuyama Corp. or FBI from FuMaTech. Possible cation-exchange membranes are, for example, Neosepta CMX and CMB membranes from Tokuyama Corp., Selemion CMV from Asahi Glass or Nafion 350 and 450 from DuPont. Anion-exchange membranes can be, for example, Neosepta AMX or ACS from Tokuyama Corp. or Selemion AMV or ASV from Asahi Glass.

The current density or electrical voltage used in the process according to the invention depends on the process parameters and lies within the specialized knowledge of the person skilled in the art or can be found without unreasonable effort. The concentration of ions, the type and number of the membranes, the arrangements and dimensions of the chamber and the temperature can be crucial.

Preferably, the membrane electrolysis is carried out in a temperature range from 0° C. to 90° C. and at current densities of 1 to 1000 mA/cm². Since the organic acids, in particular KGA and ascorbic acid, are heat-sensitive, a temperature which is as low as possible is chosen, preferably between 10° C. and 40° C. In the case of the electrodialysis, the process is carried out at 0° C. to 60° C., preferably between 20° C. and 40° C., and at current densities of 1 to 500 mA/cm², particularly preferably at 50 to 150 mA/cm². 20° C. and 40° C. and 50 to 150 mA/cm² are most preferred.

In a further preferred embodiment, in the liberation step of the process according to the invention the free organic acid is liberated only to a degree of liberation of 60% to 99%, preferably to 80% to 95%, relative to the total content of the salt of the organic acid in the crystal solution or the feed solution of the electromembrane process. Advantageously, the liberation of acid does not take place completely by means of the electrodialysis, but takes place only up to a degree of liberation of at most 99%. The residual counterions (inter alia Na, K) are removed by a conventional cation exchanger or another suitable process for the liberation of residual acid, e.g. treating with HCl. The use of cation exchangers is preferred. Numerous acidic ion exchange resins known to the person skilled in the art suit, e.g. are macroporous or gelatinous resins formed from crosslinked or noncrosslinked polymers having functional groups, such as, for example, —SO₃⁻ or —CO₂⁻, for example Lewatit S2528 or S100 from Bayer AG or Nekrolith RP or RPS from Mitsubishi Chemical Corporation.

The liberated acid can then be crystallized, dried or further processed directly in solution. Thus aqueous KGA, for example, can be directly esterified. The dried KGA can then be esterified with an alcohol as described below, advantageously with a C₁- to C₄-alcohol. Should the purity of the product not be adequate, a crystallization as described above can be carried out.

Advantageously, KGA liberated by the process according to the invention is employed as an important intermediate for ascorbic acid preparation and can thus contribute significantly to an overall optimum of an ascorbic acid preparation. KGA esters are intermediates in the preparation of ascorbic acid. In particular for the preparation of ascorbic acid, in industrial processes free KGA is esterified with a branched or unbranched C₁- to C₈-alkyl alcohol, e.g. with methanol, ethanol, n-butanol, isobutanol, 1-propanol, 2-propanol, pentanol, etc. The present invention thus relates in one embodiment also to a process for the preparation of an ester of an organic acid, preferably of an ester of 2-keto-L-gulonic acid, in particular the methyl, ethyl or butyl esters of these acids, the process including the steps of the process described above and furthermore the liberation of the acid and the esterification of the free acid. The liberation and esterification can be carried out according to processes such as have been described above or are described, for example, in the cited EP 0 805 210.

Consequently, the present invention also relates to a process for the preparation of ascorbic acid, comprising the steps of the process described above and furthermore, one or more of the following steps: lactonization of the KGA and of the KGA ester to give ascorbic acid, isolation of the crude ascorbic acid. Optionally, the process additionally contains one of the following further steps:

Liberation of the ascorbic acid from its salt, decolorization of the ascorbic acid and/or of the ascorbic acid salt, isolation and high purification of the ascorbic acid.

Advantageously, the organic acid in the process according to the invention is isolated under neutral to alkaline conditions. Thus side reactions, such as, for example, the lactonization of KGA to ascorbic acid, are reduced, preferably excluded. Advantageously, in the process according to the invention the isolation of highly pure 2-keto-L-gulonate for the preparation of ascorbic acid is carried out in an early process step before the isolation of the final product ascorbic acid, which leads to fewer by-products in the subsequent steps of the process and thus to an improved quality, yield and purity of the final product. The purified acid can be esterified and lactonized, as described in the literature.

In a further embodiment, the process product, in particular Na KGA, KGA, ascorbate or ascorbic acid, has a purity of more than 80%, more preferably more than 90%, even more preferably more 20 than 95%, most preferably of more than 98%.

The invention is illustrated with the aid of the following figures:

FIG. 1 shows the principle of the liberation of KGA in the bipolar electrodialysis with 2 circulations/2 chambers.

FIG. 2 shows principle of the liberation of KGA in the bipolar electrodialysis with 3 circulations/3 chambers.

The present invention is illustrated by the following examples, without these being regarded as restrictive in any manner.

### EXAMPLE 1

A fermentation solution which is freed from cell mass by means of filtration, but otherwise untreated, is introduced into a 3 l double-wall laboratory crystallizer and boiled at 60° C. by means of jacket heating in vacuo according to the conditions known to the person skilled in the art. 3000 g/h of a fermentation solution having an Na KGA content of 10% are introduced continuously by means of balance addition control into the crystallizer, while 2450 g of evaporated water are removed from the system by means of a condenser. A solids content of about 40% is established here in the suspension. Regulated by filling level, a suspension stream of 550 g/h is drained semicontinuously via a bottom drainage valve into a vessel evacuated to the same vacuum. From this reservoir, a second precipitation vessel is charged in which 140 g/h of the precipitating agent methanol are added to the suspension at normal pressure under reflux. The suspension having a solids content of 42% is removed semicontinuously. After centrifuging off on a laboratory centrifuge, washing with cold water and drying in a vacuum drying oven at 30° C., Na KGA is obtained as a white to slightly yellow-tinged solid containing water of crystallization. In the stationary state, 294 g/h of Na KGA monohydrate having a purity of 99.8% are obtained with feeding-back of the salt-containing wash solutions. The yield is 98% based on the KGA content of the feed solution.

### EXAMPLE 2

### Comparison Example

The same experimental setup is operated under identical conditions to those in Example 1, but without the subsequent methanol precipitation. Under these experimental conditions, Na KGA monohydrate is obtained as a yellowish-brownish-colored solid of purity 98.5% in a yield of only 73%.

### EXAMPLE 3

A solution which, in addition to 16% by weight of Na KGA prepared by fermentation, also contains 40 ppm of Mg, was treated with a chelate-forming ion-exchange resin for the removal of the Mg. For this, 3 kg of the solution described above were passed through a column of 3 cm diameter packed with 160 g of Amberlite 718 ion-exchange resin. In this process, Mg ions were removed from the solution down to a content of below 5 ppm.

### EXAMPLE 4

The solution obtained in Example 1 was divided into three portions of 1 kg each. The individual portions were then employed in the acid cycle of an electrodialysis with bipolar membranes for the liberation of acid.

The electrodialysis module was equipped with, in each case, 5 Neosepta BP-1 membranes as bipolar membranes, 5 Neosepta CMX membranes as cation-exchange membranes and 2 Neosepta C66F membranes as final membranes. The electrode material used was platinum. The effective membrane area of a membrane was 37 cm². The spacer between the membranes had a thickness of 1 mm. The electrolyte employed was 5% strength by weight sulfuric acid. The base cycle charge was a 0.5% strength by weight sodium hydroxide solution (500 g).

The three electrodialysis experiments were carried out with a current density restriction to 80 mA/cm² and a cell voltage 20 restriction of 20 V. The experimental period was 1½, 2 and 3 hours in order to achieve various degrees of depletion. The results are documented in the following table.

| | Running | | Degree of | Energy |
|---|---|---|---|---|
| Experiment | time | Capacity | liberation | requirement |
| No. | [h] | [kg/(hxm²)] | of acid [%] | [kWh/kg KGA] |
| 1 | 1.5 | 4.67 | 90.0 | 0.498 |
| 2 | 2 | 3.44 | 96.1 | 0.663 |
| 3 | 3 | 2.34 | 98.2 | 1.254 |

As acid cycle discharge, a 14% strength by weight KGA solution was obtained, as base cycle discharge an approximately 4% strength by weight sodium hydroxide solution. The losses of KGA in the base cycle were below 1%.

1. A process for the isolation of a salt of an organic acid from a fermentation broth, comprising:
a) partial evaporative crystallization; and
b) displacement precipitation of the salt.

2. The process as claimed in claim 1, wherein from 10 to 95% of the water included in the fermentation broth is evaporated and KGA crystallizes.

3. The process as claimed in claim 1, wherein the fermentation broth comprises at least 5% of the salt of an organic acid.

4. The process as claimed in claim 1, wherein the partial evaporative crystallization being carried out with the following parameters:
i) temperature in the crystallizer between 20° C. and 100° C.;
ii) pressure between 0.01 and 1.0 bar;
iii) solids content in the crystallizer from 5 to 60% by weight; and/or
iv) cooling of the concentrated fermentation broth to 0° C. to 50° C.

5. The process as claimed in claim 1, wherein the partial evaporative crystallization being carried out with the following parameters:
i) temperature in the crystallizer between 40° C. and 70° C.;
ii) pressure between 0.1 and 0.3 bar;
iii) solids content in the crystallizer from 25 to 50% by weight; and
iv) cooling of the concentrated fermentation broth to 30° C. to 40° C.

6. The process as claimed in claim 1, wherein the evaporative crystallization being carried out with the following parameters:
i) addition of methanol, ethanol, 1-propanol, 2-propanol, acetone, and/or 2-butanone as displacing agent;
ii) precipitation with 10% to 80% of displacing agent with respect to the fermentation broth; and/or
iii) temperature in the precipitation apparatus from 0° C. to 100° C.

7. The process as claimed in claim 1, wherein the displacement crystallization being carried out with the following parameters:
i) addition of methanol, ethanol or 2-propanol as displacing agent;
ii) precipitation with 20% to 40% of displacing agent; and
iii) temperature in the precipitation apparatus from 20° C. to 60° C.

8. The process as claimed in claim 1 wherein the organic acid being lactic acid, a ketogulonic acid, citric acid, vanillic acid, idonic acid, ascorbic acid or gulonic acid.

9. The process as claimed in claim 1, wherein the organic acid being 2,4-diketo-D-gulonic acid, 2,5-diketo-D-gulonic acid or 2-keto-L-gulonic acid.

10. The process as claimed in claim 1, wherein the salt being a sodium, magnesium, potassium and/or calcium salt.

11. The process as claimed in claim 1, wherein the biomass and/or inorganic or organic impurities of the fermentation broth being reduced.

12. The process as claimed in claim 1, wherein the process further comprises:
i) separation of organic and inorganic impurities from the fermentation broth by means of filtration.

13. A process for the preparation of a free organic acid from its salt and of a corresponding hydroxide of the salt, comprising the process as claimed in claim 1 and further comprising:
a) dissolution of the crystals of a salt of an organic acid in water or an aqueous solution, so that a crystal solution results;
b) removal of the multivalent cations from the crystal solution; and
c) liberation of the organic acid from the crystal solution.

14. A process as claimed in claim 13, wherein the multivalent cations being removed from the solution to a content of less than 15 ppm.

15. The process as claimed in claim 13, which further comprises:
liberation of the acid by means of an electromembrane process step.

16. The process as claimed in claim 15, wherein the electromembrane process step the cation (counter cation) and/or the anion of the dissolved salt of an organic acid is/are separated from the crystal solution in an electric field by means of one or more ion-selective ion-exchange membrane and can react with the simultaneously generated protons and hydroxide ions or with protons and hydroxide ions which are made available, so that the free organic acid and the corresponding hydroxide of the counter cation is prepared.

17. The process as claimed in claim 1, wherein the liberation of the acid being carried out by means of an electromembrane process to a degree of release of 60% to 99% relative to the total content of the salt of the organic acid in the crystal solution or the feed solution of the electromembrane process.

18. The process as claimed in claim 17, which further comprises:
removal of the cations not removed in the electromembrane process by means of a cation-exchange step.

19. A process for the preparation of an ester of an organic acid, the process comprising the steps of the process as claimed in claim 1, which further comprises:
i) esterification of the isolated organic acid with a C₁-C₆-alkyl alcohol.

20. A process for the preparation of ascorbic acid, the process comprising the steps of the process as claimed in claims 1, the organic acid being 2-keto-L-gulonic acid, and which further comprises:
i) lactonization of the KGA esters; and
ii) isolation of the crude ascorbic acid.
